(19) United States
(12) Patent Application Publication
(10) Pub. No.: US 2014/0322680 A1
(43) Pub. Date: Oct. 30, 2014

(54) Educational System for Creating Mathematical Operations

(71) Applicant: John Vasconcellos, San Francisco, CA (US)

(72) Inventor: John Vasconcellos, San Francisco, CA (US)

(21) Appl. No.: 13/869,381

(22) Filed: Apr. 24, 2013

(51) Int. Cl. G09B 7/02

(52) U.S. Cl. CPC G09B 7/02
USPC 434/188

(57) ABSTRACT

A system for learning mathematics related to the abacus method for both performing mathematical operations and storing a tally for the result of the latest operation. A computer display comprises a series of cells that are populated during a mathematical operation by dragging a finger or stylus across a cell or cells. The direction in which the finger or stylus is dragged determines the operator, and the number of cells chosen is used with said operator. Operations include addition, subtraction, multiplication, division, and negative multiplication.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to visual systems for learning. More specifically, the present invention relates to computer software applications use for teaching. More specifically, the present invention relates to methods for teaching and learning basic Mathematical operations including the abacus method.

2. Description of Related Art

The related art includes computerized methods and displays for learning how to perform mathematical operations. The related art also includes complex instructional tools to be used by student and instructor together.

There does not exist, however, the present invention which simulates and enables the benefits of the abacus method for doing mathematical operations which include enhancing numerical memory and spatial learning simultaneously.

### SUMMARY OF THE INVENTION

The present invention comprises a computer software application that employs the abacus method to enable visual learning of basic mathematical operations such as addition, subtraction, multiplication, and division (as expressed by operator symbols). A number of independent units (“dots”) on a grid pattern may each populate one cell in a grid pattern where said cell may contain one or zero dots. A grid may contain a sufficient number of cells to enable operations with large numbers of dots (operands). Operators are chosen either by use of a keypad located on the screen or a keyboard and/or by dragging a cursor or a finger across a screen in a certain direction which also causes a space(s) to populate or depopulate with a dot(s).

It is therefore an object of the present invention to teach users basic mathematical operations via the established abacus method.

It is another object of the present invention to comprise a visual learning system for use on any kind of computer, laptop, notebook, mobile device, or any other device capable of achieving the objects of the present invention

It is another object of the present invention to enable a user to visually interact with a mathematical operation whereby the function of an operator is replicated in a visual manner on a population of dots so that the user can see visually how an operator affects the population of a group of dots.

It is another object of the present invention to enable spatial learning of numbers and mathematical operations by enabling a user to physically select a dot or group of dots by dragging a finger or a cursor or similar across a cell or cells on a grid.

It is another object of the present invention to enable a user to visually interact with a mathematical operation by enabling selection of an operator via dragging a finger or cursor in a certain direction over a number of dots.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

The characteristics and utilities of the present invention described in this summary and the detailed description below are not all inclusive. Many additional features and advantages will be apparent to one of ordinary skill in the art given the following detailed description.

### BRIEF DESCRIPTION OF THE DRAWINGS

FIG. 1 is a chart that describes five corresponding elements to the present system: user action; cell population; operator; equation field text; and answer field text.

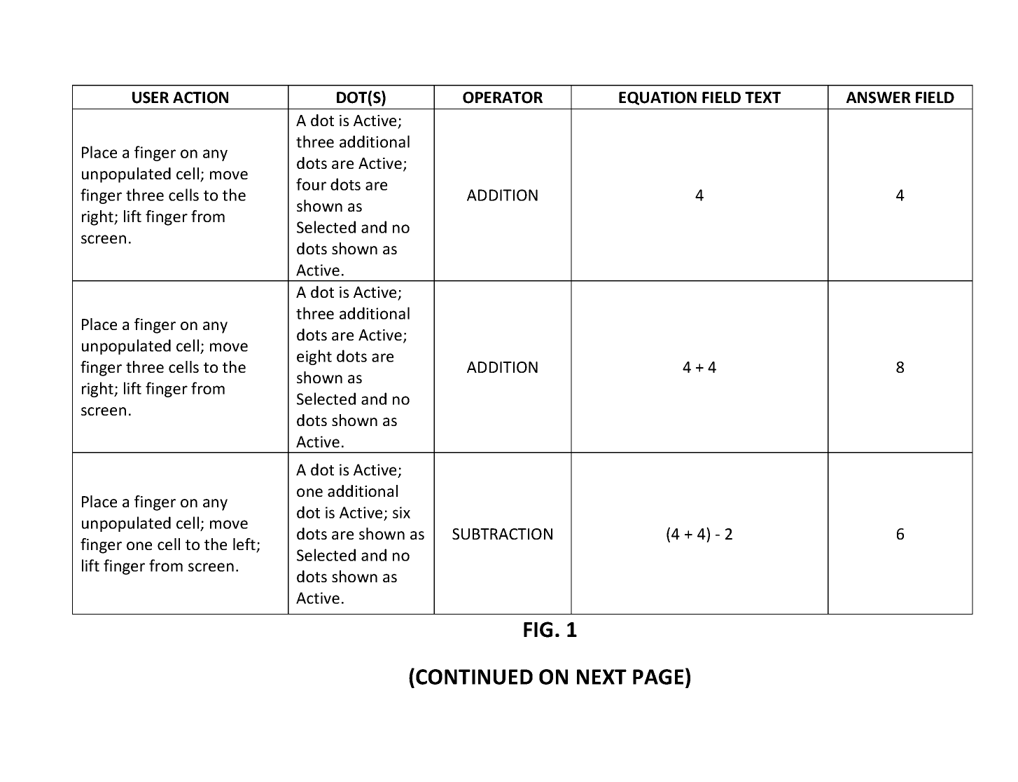

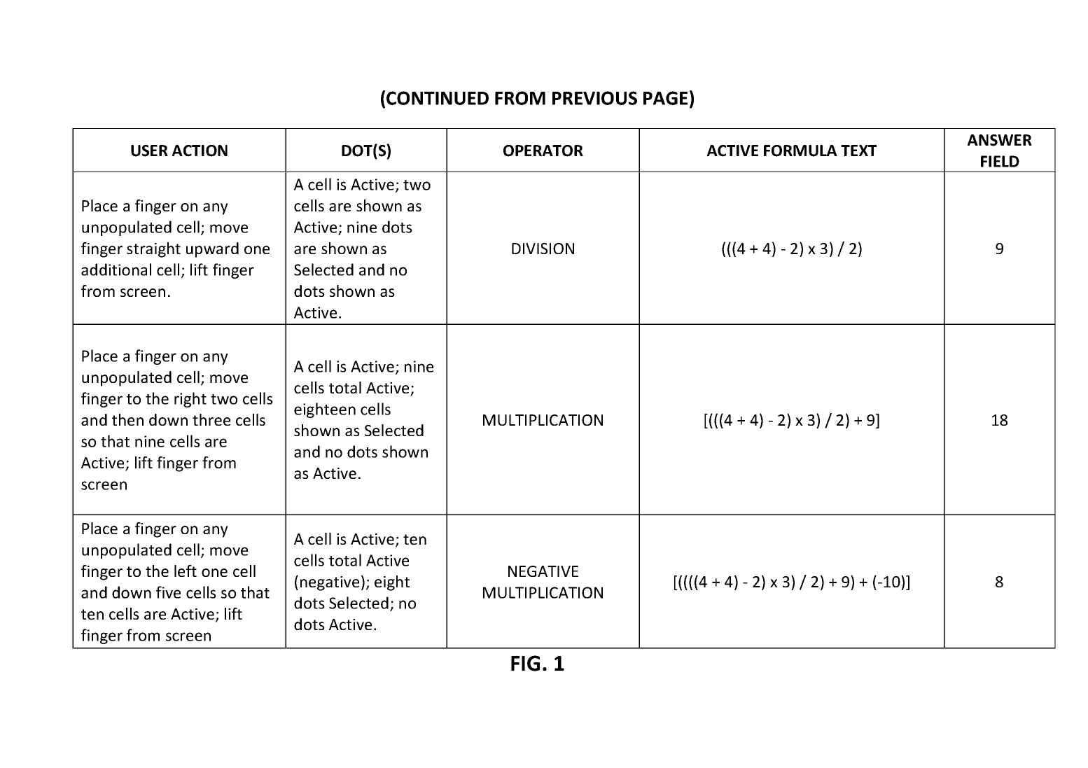

### DETAILED DESCRIPTION

The present invention comprises in part a display including a grid comprising a plurality of cells (herein “board”); an “equation field” showing current operation numerical operators, operators, and operations; and a keypad including selectable numbers and operators.

A board on the screen begins with a 7×12 grid of empty cells. In use, an empty cell can be unpopulated, populated by a smaller dot (an “Activated” cell), or populated by a larger dot (a “Selected” cell). The board expands as the number of Selected or Active cells grows up to a 60×35 grid for a total of 2,100 cells. The cells and dots decrease in size proportionally as the number of cells increases.

While touching the screen, a user chooses a number of cells by dragging a finger or stylus over a cell or series of cells; a mathematical operator is simultaneously chosen whereby the direction of finger or stylus movement during cell population determines the operator. The cells currently being populated with dots by a user for an operation are called “Active” or “Activated” cells. These are smaller than Selected dots (see next paragraph) to show which area on the board is part of the math operation while the user is dragging their finger on the board. Once the user lifts their finger from the screen the Active dots disappear and the math operation is performed. Active dots can occur anywhere on the board including over existing Selected dots.

“Selected” cells are populated cells whereby the number of selected cells add up to the current answer which is numerically represented in the answer field. A subtraction operation, for example, will result in less Selected dots. The number of Selected dots on the screen are always equal to the answer field. Selected dots are always in the upper left part of the screen. An equation bar at the top of the screen keeps track of prior math operations which accumulate until the user clears the board. An answer field at the top right shows the current total of all the operations and is always the same as the number of Selected dots on the board. answer s are limited to between −2,100 and +2,100 which is the maximum number of dots on the screen. A function with a result outside of that range will display an error message. A small text field (“active equation” field) by the user's finger indicating what math operation will be performed by the current gesture being made on the tablet. The active equation field constantly updates as the user drags their finger around the board.

To execute the functions of the calculator the software layer measures the angle of the degree of each drag gesture. In a preferred embodiment, a user first touches (with a finger on a touchscreen or a cursor using a mouse) a point on the board and moves their finger away from said point along the plane of the screen. The direction moved from said point determines the operator:

350 to 10 degrees: Division;
10 to 85 degrees: Multiplication;
85 to 95 degrees: Addition;
181 to 265 degrees: Negative Multiplication;
265 to 275 degrees: Subtraction; and
275 to 349 degrees: Negative Multiplication.

When the user touches the Board and moves in a direction between 95 and 180 degrees away from the starting point, a multiplication function is registered. The selection will create a square or rectangle to the lower right of the starting point whose dimensions equal the multiplication operation. For example, if the user drags their finger 3 dots to the right and 5 dots down, the software application will interpret that gesture as 3 multiplied by 5. The active equation field text will be “3×5”. There will also be 15 Active dots on the screen forming a rectangle from the initial touch on the screen to the point at which the user has dragged. If the user lifts their finger at that point the answer field and the Selected dots will reflect the previous total plus 15.

In use for Negative multiplication (Subtracting an area from the total): this works similar to the Multiplication function but results in subtracting the selection. When the user touches the Board and moves in a direction between 275 and 349 degrees away from the starting point, a negative multiplication function is registered. For example, if the user drags their finger 4 dots to the left and 6 dots up, the software application will interpret that gesture as subtracting the total of 4 multiplied by 6. The active equation field text will be “−(4×6)”. There will also be 24 Active dots on the screen forming a rectangle from the initial touch on the screen to the point at which the user has dragged. If the user lifts their finger at that point the answer field and the Selected dots will reflect the previous total minus 24.

When the user drags their finger to the right about 90 degrees from their initial touch of the screen, an addition function is registered whereby the Active dots will form a line along which the user has dragged their finger. The addition operation is equal to the number of dots that the user has dragged to the right. If the user drags 5 dots to the right then the active equation field text will show “+5”. There will also be 5 Active dots forming a straight line from the initial touch to where the user has dragged their finger. If the user lifts their finger at that point the answer field and the Selected dots will reflect the previous total plus 5.

When the user drags their finger to the left about 270 degrees from their initial touch of the screen, a subtraction function is registered. The Active dots will form a line along which the user has dragged their finger to the left. The subtraction operation is equal to the number of dots that the user has dragged to the left. If the user drags 5 dots to the left then the active equation field text will show “−5”. There will also be 5 Active dots forming a straight line from the initial touch to where the user has dragged their finger. If the user lifts their finger at that point the answer field and the Selected dots will reflect the previous total minus 5.

When the user drags their finger to the top of the screen at between 350 to 10 degrees from their initial touch of the screen, a division function is registered. The Active dots will form a line along which the user has dragged their finger upwards. The division operation is equal to the number of dots that the user has dragged to the top of the screen. If the user drags 5 dots upwards then the active equation field text will show “/5”. There will also be 5 Active dots forming a straight line from the initial touch to where the user has dragged their finger. If the user lifts their finger at that point the answer field and the Selected dots will reflect the previous total divided by 5 at up to 2 decimal places. This function will display an error message if the previous total was zero.

The previous is a detailed description of embodiments of the present invention. As these embodiments of the present invention are described, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description is not to be considered in a limiting sense, as it is understood that the present invention is in no way limited to the embodiments described.

What is claimed is:

1. A system for teaching mathematics comprising:
A software application and a corresponding display comprising a board, an active equation field, an equation field, a calculator keyboard, and an answer field, whereby a user uses a motion to drag a finger or stylus across said board in order to select a numerical value and/or a mathematical operator and/or a mathematical operation corresponding with the direction(s) that said finger or stylus is dragged and/or the distance said finger or stylus is dragged whereby:
the distance that said finger or stylus is dragged across said board during said motion is used to instruct said software application what numerical value to use in an operation;
the direction that said finger or stylus is dragged across said board during said motion is used to instruct said software application what operator to use on a chosen numerical value;
said motion may indicate both numerical value and operator where the direction of the motion indicates operator and the distance traveled indicates numerical value;
said motion may include one or more directional changes before a finger or stylus is lifted to conclude the motion; a motion including a directional change indicates the selection of a mathematical operation comprising the quantity in the square or rectangular area defined by the two distinct distances traveled as measured from finger or stylus initial contact to point of directional change, and from point of directional change to point of finger or stylus lifted from said screen; the two said distances are multiplied together to comprise the numerical value chosen by the user; and
said active equation field constantly updates the current chosen equation while a finger or stylus is creating a motion, so as to show a user current equation results, operands, operators, and/or operations at the present point on the board and per the direction traveled by said finger or stylus; and
said equation field displays the current chosen equation whereby the result of said equation is displayed in said answer field.

2. The board of claim 1 comprising a plurality of cells whereby:
a cell is either unpopulated, activated, or selected;
an activated cell is one that is populated with a visual indicator during the process of choosing a cell or cells for the purpose of creating a value to be used as part of a mathematical operation and/or as a singular mathematical operation; and
a selected cell is one that is populated with a visual indicator and comprises part of a visual tally for the value of the mathematical operation being performed;
said tally is indicated numerically in the answer field; and
a selected cell is visually distinct from an activated cell.
